(19) United States
(12) Patent Application Publication
(10) Pub. No.: US 2019/0005762 A1
(43) Pub. Date: Jan. 3, 2019

(54) CONTROL SYSTEM FOR A FUEL DISPENSER

(71) Applicant: Michael A. Racusin, Chicago, IL (US)

(72) Inventor: Michael A. Racusin, Chicago, IL (US)

(21) Appl. No.: 15/636,241

(22) Filed: Jun. 28, 2017

(51) Int. Cl. G07F 13/02; G07F 15/00; G06Q 30/02; G06Q 50/06; G06Q 20/28; G06Q 20/20; B67D 7/22

(52) U.S. Cl. CPC G07F 13/025; G07F 15/001; G06Q 30/0283; B67D 7/227; G06Q 20/28; G06Q 20/204; B67D 7/221; G06Q 50/06

(57) ABSTRACT

An improved control system for a fuel dispenser is disclosed that enables fuel dispensers to process prepaid gas cards based upon a discounted wholesale cost or a non-discounted price that is locked in at the time of the purchase without taking delivery. The control system has access to a snap shot of the regional wholesale gasoline costs across an entire region, such as the US, at the time of purchase of the prepaid gas card. This enables the prepaid gas card to provide a discount on the wholesale cost component of a gallon of gas at any location across the entire region. Since the discount only applies to one component of the retail gas price per gallon; namely, the wholesale gas cost per gallon, the control system automatically calculates a discounted retail gas price at the time and location of delivery based upon the discounted or locked in wholesale cost at the time of purchase of the prepaid gas card. The prepaid gas discount card is received in a magnetic card reader at the fuel dispenser in the same manner as conventional credit cards and provides a wholesaler the ability to create an elastic demand for the gas and regain customer loyalty for gas credit cards.

### BACKGROUND OF THE INVENTION

### 1. Field of the Invention

The present system relates to fuel dispenser for dispensing gasoline with improved functionality which enables the dispenser to process uniform wholesale discounts across an entire region in which wholesale costs to retailers normally vary.

### 2. Description of the Prior Art

Fuel dispensers, used in retail gas stations, are widely known in the art. Examples of such fuel dispensers are disclosed in U.S. Pat. Nos. 9,302,899; 9,139,414; and 9,082,248, hereby incorporated by reference. Such fuel dispensers include two main systems; an electronic system and a mechanical system. The mechanical system generally includes an electric motor, a pump, and valves required to control the fuel flow under the control of the electronic system. The electronic system includes an embedded computer to control the operation of the pump and the displays, a magnetic card reader and a bi-directional communication system for communicating with credit card companies relating to the payment of retail sales.

Typically, a retail customer inserts a credit card into the magnetic card reader in the fuel dispenser. The electronic system reads the data on the magnetic strip on the credit card and checks available credit or balance in the purchaser's account. Once the purchaser's account balance has been verified, the electronic system enables the electric motor that drives the pump to be manually controlled by a lever in the pump handle. A hose is connected to the pump and to a dispensing nozzle. Actuation of the manually operated lever in the nozzle allows for manual control of the pump while the electric motor is enabled.

In addition to credit cards, prepaid gas discount cards are known for purchasing gas at fuel dispensers at retail gas stations. One problem with such prepaid gas discount cards is that the discount normally applies to the entire per gallon price. The price of a gallon of gas is comprised of multiple components; the per unit (i.e. per gallon) wholesale cost+per unit taxes and per unit local fees. The per unit local fees and costs including delivery charges, charges associated with the retail gas station and owner profit. Each of these components is known to vary based upon the location of the retail gas station. As such, known prepaid gas discount cards are generally limited to a region.

Prepaid gas discount cards which normally provide a fixed discount on the entire unit price of a gallon of gas create a problem for wholesalers because of the variability of wholesale gas cost by location. Since gas wholesalers operate in regions in which there are multiple wholesale gas cost, such prepaid gas discount cards have been of little interest to wholesalers. This is due to the inability of the wholesaler to provide a uniform discount on only the wholesale gas component of the gas price in such regions.

One attempt to solve this problem for wholesalers is disclosed in Wanasek US Patent Application Publication No. US 2004/0260632 A1 (“Wanasek”). Wanasek discloses a prepaid commodity card in which gallons of gasoline can be pre-purchased from a wholesaler at fixed per unit wholesale cost. There are several problems with the Wanasek methodology. One problem is that the prepayment only covers the wholesale cost of gas and does not include per unit taxes and per unit local fees, thus requiring taxes and local fees to be handled in a separate transaction. Another problem is that the currency of the Wanasek card is gallons making the card unsuitable for use at conventional fuel dispensers that accept conventional credit cards based on cash. Thus, such transactions would have to be handled by an attendant.

Another problem with the system disclosed in Wanasek publication is that it does not consider regional variances in crude oil prices. As published by NACS, 65% of the price of a gallon of gas is based on the cost of crude oil. As illustrated in FIGS. 4A and 4B, there is a wide variance in crude oil prices in different regions across the US which would have a significant impact on the regional wholesale unit gasoline cost. A wholesaler would need to constrain the use of the commodity card to a region. For example, if a user purchased a prepaid commodity card in a region where the crude oil price is $17.38 per barrel, say West Virginia, unless the gas discount card was geographically constrained, the card could theoretically be used in a region, such as Louisiana, where the price per barrel of crude is $28.10 per barrel. The gas discount card would thus need to be constrained to locations where wholesale cost is constant. This would be would be difficult if not impossible to administer for wholesalers.

Other types of gas discount cards that are based upon a discount to the price of a gallon of gas are also not useful for wholesalers. As mentioned above, taxes on a gallon of gas vary by location. Since taxes cannot be discounted, the discount would need to apportion between the other components of a gallon of gas; namely the per unit wholesale gas cost and the per unit local fees—also impossible for a wholesaler to administer.

Thus, there is a need for a fuel dispenser that is configured to process prepaid gas cards that include a wholesale discount or are based upon a fixed wholesale cost that is locked in at the time of purchase and can be used across regions with differing wholesale costs.

### SUMMARY OF THE INVENTION

An improved control system for a fuel dispenser processes prepaid gas cards which provide a discounted wholesale cost or a non-discounted price that is locked in at the time of the purchase without taking delivery. The control system has access to a snap shot of the regional wholesale gasoline costs across an entire region, such as the US, at the time of purchase of the prepaid gas card. This enables the prepaid gas card to provide a discount on the wholesale cost component of a gallon of gas at any location across the entire region. Since the discount only applies to one component of the retail gas price per gallon; namely, the wholesale gas cost per gallon, the control system automatically calculates a discounted retail gas price at the time and location of delivery based upon the discounted or locked in wholesale cost at the time of purchase of the prepaid gas card. The prepaid gas discount card is received in a magnetic card reader at the fuel dispenser in the same manner as conventional credit cards and provides a wholesaler the ability to create an elastic demand for the gas and regain customer loyalty for gas credit cards.

### DESCRIPTION OF THE DRAWING

These and other advantages of the present invention will be readily understood with reference to the following specification and attached drawing wherein:

FIG. 1A is an elevation view of an exemplary fuel dispenser.

FIG. 1B is a block diagram of a fuel dispenser as described herein.

FIG. 2 is a block diagram of an exemplary system for implementing the fuel dispensers disclosed herein.

FIG. 3 is an exemplary flow chart of the fuel dispenser disclosed herein.

FIGS. 4A and 4B illustrate a Table of cost in various locations at a fixed point of time.

### DETAILED DESCRIPTION

An improved control system for a fuel dispenser is configured to accept prepaid discount gas cards that only provide a discount on the wholesale gas cost, which is only one component of the retail gas cost. Such prepaid gas discount cards allow a gasoline wholesalers to build brand loyalty and provide an elastic demand curve. More specifically, the wholesaler can increase sales by increasing the wholesale discount or decrease sales by decreasing the discount depending on the current supply of gasoline.

Conventional prepaid gas discount cards which provide a discount on the entire retail unit price are of little use to wholesalers. Such conventional cards provide variable wholesale cost discounts dependent upon the variable prices of other components of the retail gas price.

There are consumer advantages of a prepaid discount card that provides discounts on the wholesale gas cost component of the retail gas price. For example, the consumer could use the prepaid gas card in any gas station without geographic constraint. Known gas discount cards are typically constrained to a particular region because the various components of the retail gas price vary by location.

The improved control system for a fuel dispenser processes prepaid gas cards which provide a discounted wholesale cost or a non-discounted price that is locked in at the time of the purchase without taking delivery. The control system has access to a snap shot of the regional wholesale gasoline costs across an entire region, such as the US, at the time of purchase of the prepaid gas card. This enables the prepaid gas card to provide a discount on the wholesale cost component of a gallon of gas at any location across the entire region. Since the discount only applies to one component of the retail gas price per gallon; namely, the wholesale gas cost per gallon, the control system automatically calculates a discounted retail gas price at the time and location of delivery based upon the discounted or locked in wholesale cost at the time of purchase of the prepaid gas card. The prepaid gas discount card is received in a magnetic card reader at the fuel dispenser in the same manner as conventional credit cards and provides a wholesaler the ability to create an elastic demand for the gas and regain customer loyalty for gas credit cards.

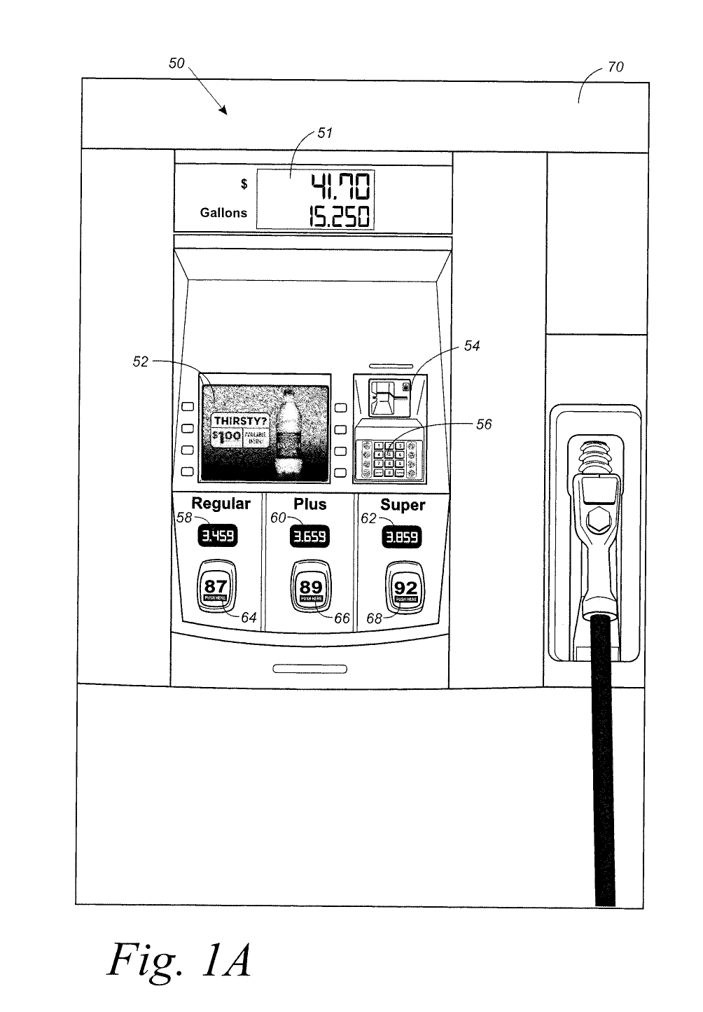

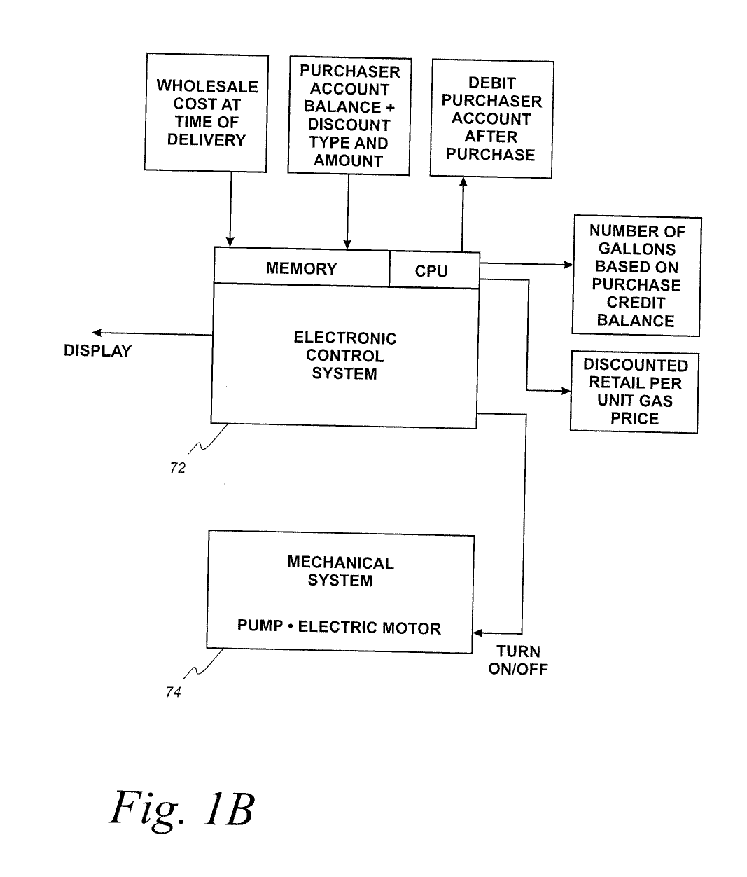

An exemplary fuel dispenser is illustrated in FIG. 1. The fuel dispenser, generally identified with the reference numeral 50, includes a main display 51 for displaying the gallons pumped and the price and an optional supplemental display 52 for advertising, a magnetic card reader 54, a keyboard 56, three price displays 58, 60 and 62 and three paddles 64, 66 and 68, typically for 87, 89 and 93 octane gasoline, to enable selection of the desired grade of gas, all carried by a common free-standing housing 70. The fuel dispenser 50 may incorporate similar mechanical and electric hardware as disclosed in U.S. Pat. Nos. 7,948,376; 9,302,899; 9,139,414; and 9,082,248, hereby incorporated by reference.

Conventional fuel dispensers can easily process discounts on the overall per unit price of gas but are unable to process discounts on a per unit price component, such as the wholesale per unit cost. Unlike conventional fuel dispensers, the fuel dispenser 50 provides an enhanced ability to process prepaid gas cards with wholesale discounts or fixed wholesale costs at the time of purchase of the prepaid gas card. The prepaid gas card disclosed herein is like a conventional credit card and includes a magnetic strip that enables it to be read by a conventional magnetic card reader 54.

Retail gas prices per gallon consist of several components that vary by location, as shown below.

Retail gas price=wholesale gas cost+local fees+taxes

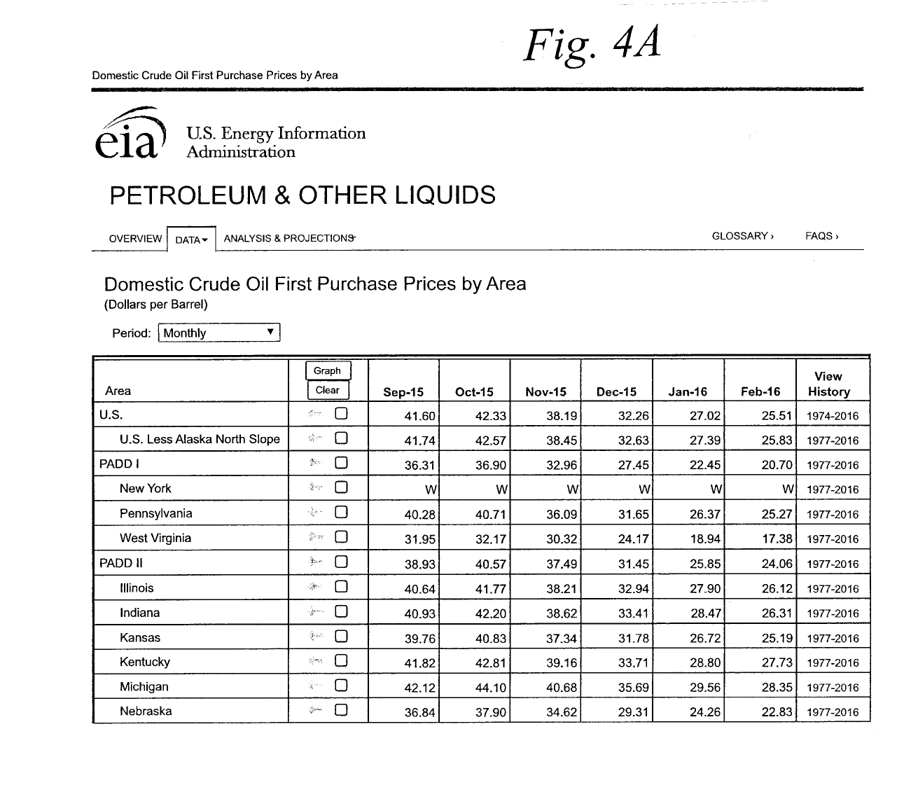

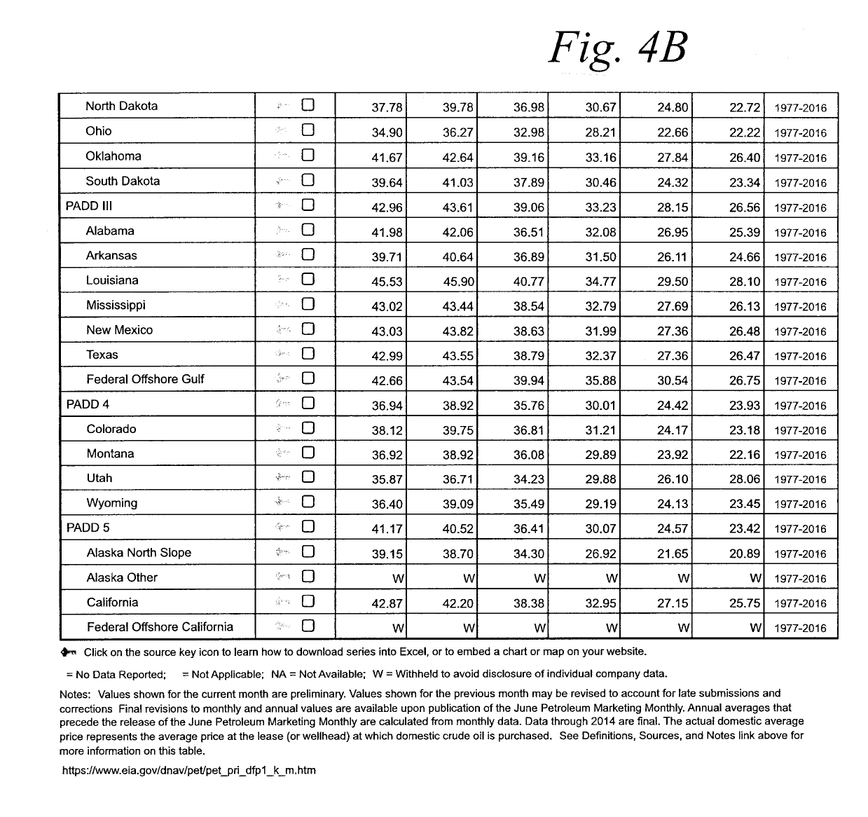

The wholesale gas cost is the price a retail gas station owner pays to a wholesale supplier. As illustrated in FIG. 4, this price varies by location. Taxes relate to the federal, state and local taxes per gallon. Taxes vary by jurisdiction (i.e. location). Local fees include various components including the retail owner's expenses and profit margin.

As used herein, the following definitions apply:
Undiscounted wholesale gas cost: This is the wholesale cost component of a gallon of gas at a given retail location.
Retail gas price: This is the price that a retailer sells a gallon of gas to a customer at a given retail location.
Discounted wholesale unit cost: This is a wholesale unit gas cost based upon a percentage discount that applies to all regional wholesale unit gas costs in a region of interest, i.e. US, at the time of purchase of the prepaid gas card. Alternatively, the discounted wholesale unit gas cost is the wholesale unit prices locked in at the time of purchase of the gas card by a consumer of all regional wholesale unit gas costs in a region of interest at the time of purchase of the prepaid gas card.

In one embodiment, the enhanced functionality of the fuel dispenser automatically recalculates regional unit retail price based upon a wholesale discount or a fixed wholesale cost at the time of purchase of a prepaid gas card. For example, assume the purchaser purchases—a $1000 prepaid gas card and takes delivery of 10 gallons of gas at a location where the discounted wholesale cost is $2.50 per gallon and the local fees and taxes are $1.00 per gallon. $35 ((2.50+1)×10) would be debited from the prepaid gas card leaving a $965 credit on the prepaid gas card. Now assume that the purchaser goes to another locale to take delivery of 10 more gallons of gas where the local taxes and local fees are $0.50 per gallon and the discounted wholesale cost is $2.00 per gallon. 10 gallons of gas at the other location would cost $25 ((2.00 0.5)×10) leaving a credit of $940 on the prepaid credit card.

The prepaid gas card may be a fixed discount on the wholesale cost, for example 10%, a dollar amount, such as $0.30/gallon or a fixed wholesale cost at the time of purchase of the prepaid gas card based upon a “snapshot” of all the wholesale per unit gas costs in effect across an entire region, e.g. 160,000 retail gas stations in the US, at the time of purchase of the prepaid gas card.

Referring to FIG. 1B, a block diagram of the fuel dispenser 50 is illustrated. The fuel dispenser 50 includes an electronic control system 72 and a mechanical system 74. The mechanical system 74 includes a pump driven by an electric motor and various control valves as known in the art, for example, as disclosed in U.S. Pat. Nos. 7,948,376; 9,302,899; 9,139,414; and 9,082,248, hereby incorporated by reference.

The mechanical system is under the control of the electronic control system 72. The electronic control system 72 includes control logic as used in conventional fuel dispensers and includes the logic disclosed below to provide enhanced functionality of the fuel dispenser 50. The electronic control system includes a CPU and memory. Several input signals are applied to the electronic control system 72, as indicated below.
wholesale per unit gas cost at retail station at the time the prepaid gas card was purchased.
purchaser account balance
discount type and amount, e.g. fixed dollar amount per gallon or percentage discount per gallon.

The electronic control system provides several output signals:
turn pump on/off
discounted retail per unit price based upon wholesale cost at the time of delivery or alternatively at the time of delivery.
number of gallons authorized based upon purchaser's account balance and the discounted retail price.

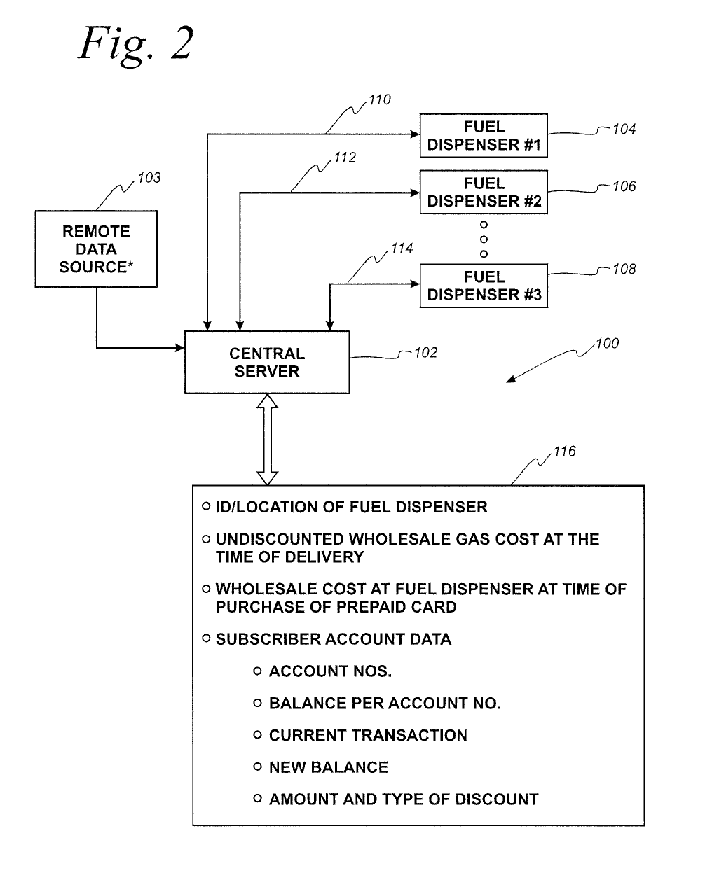

An exemplary embodiment of a system for implementing fuel dispensers with enhanced functionality as described herein is illustrated in FIG. 2 The system 100 may include at least one server 102 and one or more storage mediums 116 for storing one or more databases. The server 102 may be linked to one or more additional servers (not shown) in a conventional manner in remote geographical areas.

The server 102 is configured to receive sales data from a plurality of retail fuel dispensers 104, 106 and 108, located, for example, in different geographical areas in which the local fees and local taxes as well as differences in wholesale unit gasoline costs are different. The fuel dispensers 104, 106 and 108 may be connected to the central server 102 by way of a plurality of conventional communication links 110, 112 and 114, respectively, which may be virtually any conventional wired or wireless communication link that enable bi-directional communication between the central server 102 and the fuel dispensers 104, 106 and 108.

The central server 102 has access to one or more data sources. For example, a database may be stored on a storage medium 116 that is accessible by the central server 102. The database 116 may include purchaser account data; purchaser's account number, the current credit balance and discount and the type and amount of the discount. An external data source 103 may be provided for storing various data, such as the local wholesale gas costs across an entire region, such as, the US, at various times including the time of purchase of the prepaid gas card or alternatively, the time of delivery.

In one embodiment, the fuel dispensers 104, 106 and 108 transmit representative information to the server 102 regarding the identification and/or location of the fuel dispenser 104, 106 and 108 where the purchase was made and the amount of purchase including the number of gallons and optionally the date and time of the purchase. The central server 102 grabs the location of the fuel dispenser 104, 106 and 108 where gas is being purchased. The location of the fuel dispenser 104, 106 and 108 along with the account data and the amount and type of discount allow the server 102 to determine the discounted wholesale gas cost at the location of the fuel dispenser. Based upon this data, the server 102 determines, i.e. recalculates, a discounted retail per unit price at the time of delivery and debits the purchaser's account accordingly and optionally displays the discounted retail price the fuel dispenser's displays 51, 58, 60 and 62.

To determine the discounted retail price per gallon at the time of purchase, the server 102 takes the discounted wholesale cost at the time of purchase of the prepaid gas card minus the undiscounted wholesale cost at the time of purchase of the gas (which is likely a negative number) plus the undiscounted retail price at the time of purchase. The discounted retail gas price is determined as set forth below

Undiscounted retail gas price=undiscounted wholesale cost+local fees and local taxes

Undiscounted retail gas price−undiscounted wholesale cost=local cost and local taxes

Discounted retail gas price=undiscounted retail gas price−undiscounted wholesale cost+discounted wholesale gas cost

For example, if the undiscounted retail price is $3.00 per gallon and the undiscounted wholesale cost at the location of delivery at the time of purchase of the prepaid gas card is $2.50 and the discounted wholesale cost at the time of delivery at the location of delivery is $2.00, the discounted retail price will be $2.50 per gallon.

Based upon the purchaser's available account balance or available credit, the central server 102 determines the maximum number of gallons that can be dispensed based upon the discounted retail gas price and enables the pump to be turned on under the control of the hand-operated lever in the nozzle up to the maximum number. Should the maximum number of gallons be reached before the hand operated lever in the nozzle is released, the system will turn the pump off.

After the gasoline dispensing is terminated either by the purchaser or automatically when the purchaser's gas tank is full or when the maximum number of gallons is reached, the fuel dispenser 104, 106 and 108 sends a signal back to the central server 102 that the sale is concluded. Upon receipt of that signal, the central server 102 adjusts the purchaser's account balance. The revised balance is stored by the central server 102.

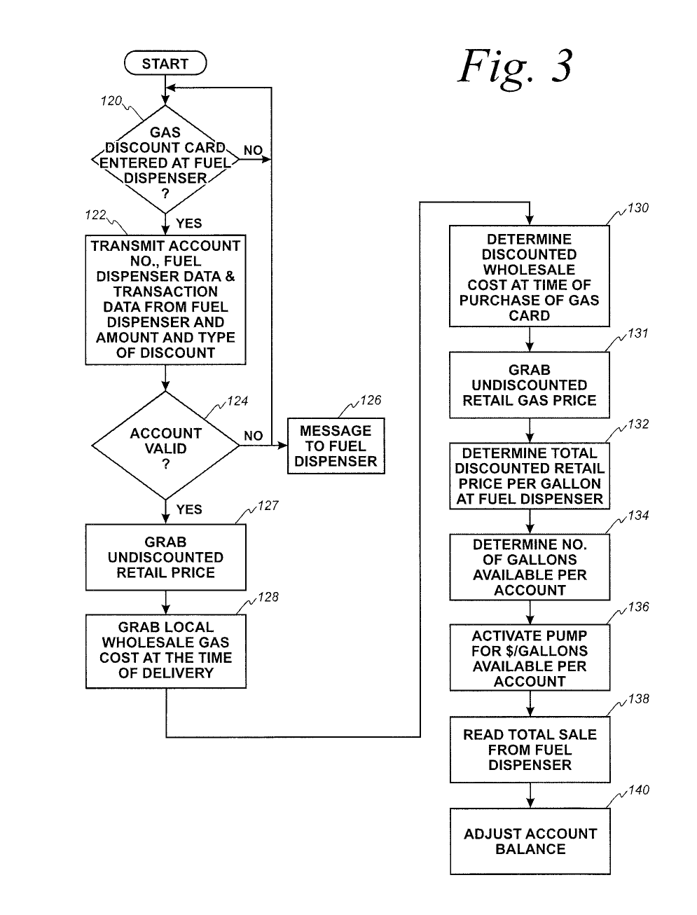

A simplified flow chart is illustrated in FIG. 3. It is to be understood that the improved functionality of the fuel dispenser is not limited to the sequence of steps set forth in FIG. 3. The process may be executed in different sequences to reach the end results, discussed above.

The system waits in step 120 for a prepaid gas card to be read by a card reader 54 (FIG. 1). Once a magnetic strip or an embedded chip is read, the purchaser account number along with the transaction data is sent to the central server 102 in step 122. The system then determines if the purchaser balance is valid in step 124. If the account is not valid, the system returns to step 120 and waits for another prepaid gas card to be swiped at the POS terminal 104, 106 and 108. In this situation, a message, such as “Account Not Valid”, may optionally be displayed by the display 52 (FIG. 1), as indicated in step 126.

If the purchaser's account is valid, the system uses the location data from the fuel dispenser read data from the fuel dispenser 104, 106 and 108 to determine its geographic location. The location of the fuel dispenser along with the purchaser's account data allow the system to access the following data from the storage device 116 (FIG. 2) and/or the remote data source 103:
Undiscounted retail price at the location of the fuel dispenser at the time of purchase of gas (step 127)
Discounted wholesale cost at the time of purchase of the gas card (step 130)
Undiscounted retail price at the time of purchase of the gas. (step 131)
Amount and type of discount

In step 132, the server 102 determines the discounted retail price, as mentioned above. In step 134, the server 102 determines the number of gallons that can be purchased based upon the discounted retail gas price per gallon and the credit balance in the purchaser's account. In step 136, the central server 102 signals the pump at the fuel dispenser to turn on. Once the pump is turned on, the central server 102 provides a signal to the fuel dispenser 104, 106 and 108 to optionally display the adjusted price per gallon, total price at the adjusted price and the number of gallons pumped. The total number of gallons dispensed by the fuel dispenser 102, 104 and 106 is displayed by the display 52 (FIG. 1) in step 138 based upon the discounted retail price. The purchaser's account is adjusted and stored as an account balance by the server 102 in step 140.

The fuel dispenser 50 will allow the pump to stay on up to the limit of the purchaser's dollar amount. Once the pumped gas reaches the limit, the central server 102 sends a signal to the POS terminal to turn it off. Alternatively, as discussed above, the pump may be turned off at the fuel dispenser 104, 106 and 108 either manually by the purchaser or automatically when the purchaser's gas tank is full or when the maximum number of gallons is reached.

The prepaid card discounts can be based upon a percentage of wholesale cost at the time of purchase of the card or alternatively a fixed wholesale cost at the time of purchase of the card. These discounts may be based upon existing wholesale costs at fuel dispensers across an entire region at the time of purchase of the prepaid discount card or at the time of delivery. Alternatively, the system can be implemented by a credit card that can be used to provide the discounts mentioned above but at the time of activation of the credit card or alternatively reaching a predetermined sales goal.

The principles of the invention are equally applicable to various regions, including regions outside of the US. For example, the principles of the invention are applicable to Europe as well as other regions outside of the US.

Obviously, many modifications and variations of the present invention are possible in light of the above teachings. Thus, it is to be understood that, within the scope of the appended claims, the invention may be practiced otherwise than as specifically described above.

I claim:

1. A fuel dispenser for dispensing gasoline, said fuel dispenser comprising:
a mechanical system which includes a pump and an electric motor for pumping gasoline; and
an electronic control system which includes a computer and memory, said electronic control system including a magnetic card reader for reading a magnetic strip on a prepaid gas card which includes data regarding the purchaser's account and type and amount of the discount on a wholesale cost component of the gasoline price as well as data regarding the an undiscounted wholesale cost component at the location of the fuel dispenser at the time of purchase of the gas discount card and recalculating the retail price per gallon based upon such data.

2. The fuel dispenser recited in claim 1, wherein said electronic control system is configured to display said recalculated retail fuel price on said fuel dispenser display.

3. The fuel dispenser recited in claim 1, wherein said electronic control system is configured to recalculate said retail fuel price at a fixed wholesale gas cost.

4. The fuel dispenser recited in claim 1, wherein said electronic control system is configured to recalculate said retail fuel price at a fixed wholesale gas cost at the time the prepaid gas card is purchased.

5. The fuel dispenser recited in claim 1, wherein said electronic control system is configured to recalculate said retail fuel price based upon a percentage of the wholesale gas cost at the time of delivery.

6. The fuel dispenser recited in claim 1, wherein said electronic control system is configured to recalculate said retail fuel price based upon a percentage of the wholesale gas cost at the time of purchase of the prepaid gas card.

7. The fuel dispenser recited in claim 1, wherein said electronic control system is configured to recalculate said retail fuel price based upon a fixed dollar amount discount of the wholesale gas cost at the time of delivery.

8. The fuel dispenser recited in claim 1, wherein said electronic control system is configured to recalculate said retail fuel price based upon a fixed dollar amount discount of the wholesale gas cost at the time of purchase of the prepaid gas card.

9. A fuel dispenser for dispensing gasoline, said fuel dispenser comprising:
a mechanical system which includes a pump and an electric motor for pumping gasoline; and
an electronic control system which includes a computer and memory, said electronic control system including a magnetic card reader for reading a magnetic strip on a gas credit card which includes data regarding the purchaser's account and type and amount of the discount on a wholesale cost component of the gasoline price as well as data regarding the an undiscounted wholesale cost component at the location of the fuel dispenser at the time of activation of the gas credit card and recalculating the retail price per gallon based upon such data.
